(19) United States
(12) Patent Application Publication
(10) Pub. No.: US 2024/0378605 A1
(43) Pub. Date: Nov. 14, 2024

(54) SYSTEMS AND METHODS FOR ELECTRONIC TICKET VALIDATION WITH NON-FUNGIBLE TOKENS IN A BLOCKCHAIN NETWORK

(71) Applicant: pe3q technologies, inc., Las Vegas, NV (US)

(72) Inventors: Ted Campos, Las Vegas, NV (US); Brian Kip, Las Vegas, NV (US)

(73) Assignee: pe3q technologies, inc., Las Vegas, NV (US)

(21) Appl. No.: 18/315,019

(22) Filed: May 10, 2023

(51) Int. Cl. G06Q 20/40; G06Q 20/04; G06Q 20/36; G06Q 20/38

(52) U.S. Cl. CPC G06Q 20/401; G06Q 20/0457; G06Q 20/3672; G06Q 20/389

(57) ABSTRACT

Embodiments of a method for electronic ticket validation with non-fungible tokens (NFTs) in a blockchain network are disclosed. The method is executed by a processor of a server in a cloud network and comprises: receiving a wallet address of a wallet in the blockchain network; querying blockchain data based on the wallet address to identify a NFT identifier in the wallet; determining whether the NFT identifier matches at least one in a list of pre-approved NFT identifiers; retrieving a digital image corresponding to the NFT identifier determined to match at least one identifier in the list of pre-approved NFT identifiers; randomly selecting an animation from a repository of mutually distinct animations; generating a combination of the selected animation and the retrieved digital image; and transmitting the combination to a ticketholder-device and to a validation-device for synchronous display by the ticketholder-device and the validation-device.

### TECHNICAL FIELD

The present disclosure relates to systems, techniques, and methods directed to electronic ticket validation with non-fungible tokens (NFTs) in a blockchain network.

### BACKGROUND

A blockchain is a decentralized, distributed digital ledger used to record transactions across many computing nodes (e.g., servers) in a network such that any ledger record cannot be altered retroactively (e.g., tampered), without alteration of all subsequent blocks on a majority of the computing nodes. As a result, blockchain technology can be useful in creating an immutable ledger that confirms data integrity, with built-in mechanisms to prevent unauthorized, unauthenticated transactions.

### BRIEF DESCRIPTION OF THE DRAWINGS

Embodiments will be readily understood by the following detailed description in conjunction with the accompanying drawings. To facilitate this description, like reference numerals designate like elements. Embodiments are illustrated by way of example, and not by way of limitation, in the figures of the accompanying drawings.

FIG. 1 is a simplified block diagram of an example system for electronic ticket validation with NFTs in a blockchain network according to some embodiments of the present disclosure.

FIG. 2 is a simplified block diagram of an example user-interface in the system for electronic ticket validation with NFTs in a blockchain network according to some embodiments of the present disclosure.

FIG. 3 is a simplified block diagram of another example user-interface in the system for electronic ticket validation with NFTs in a blockchain network according to some embodiments of the present disclosure.

FIG. 4 is a simplified block diagram of example elements in the system for electronic ticket validation with NFTs in a blockchain network according to some embodiments of the present disclosure.

FIG. 5 is a simplified block diagram of example display operations in the system for electronic ticket validation with NFTs in a blockchain network according to some embodiments of the present disclosure.

FIG. 6 is a simplified block diagram of example display operations in the system for electronic ticket validation with NFTs in a blockchain network according to some embodiments of the present disclosure.

FIG. 7 is a simplified sequence diagram showing a sequence of operations for electronic ticket validation with NFTs in a blockchain network according to some embodiments of the present disclosure.

FIG. 8 is a simplified flow diagram showing example operations for electronic ticket validation with NFTs in a blockchain network according to some embodiments of the present disclosure.

FIGS. 9A and 9B are simplified flow diagrams showing other example operations for electronic ticket validation with NFTs in a blockchain network according to some embodiments of the present disclosure.

FIG. 10 is a simplified flow diagram showing yet other example operations for electronic ticket validation with NFTs in a blockchain network according to some embodiments of the present disclosure.

FIG. 11 is a simplified block diagram showing an example computing device in the system for electronic ticket validation with NFTs in a blockchain network according to some embodiments of the present disclosure.

### DETAILED DESCRIPTION

### Overview

For purposes of illustrating the embodiments described herein, it is important to understand certain terminology and operations of blockchain networks. The following foundational information may be viewed as a basis from which the present disclosure may be properly explained. Such information is offered for purposes of explanation only and, accordingly, should not be construed in any way to limit the broad scope of the present disclosure and its potential applications.

A blockchain is a distributed ledger with growing lists of records, called blocks, securely linked together via cryptographic hashes. In general, each block contains a cryptographic hash of the previous block, a timestamp, and transaction data. Each block represents a transaction that is validated (e.g., verified) and recorded by a number of different nodes in a network, each node being a computing device. In other words, each node participating in the network holds an identical copy of the ledger, reflecting all past transactions in the blockchain. Transactions, identified by corresponding transaction identifiers (IDs), can be any movement of data in the blockchain network. Each transaction may be associated with certain transaction costs, payable to the validator nodes in the blockchain network as “gas fees.” Examples of currently available blockchain networks include Ethereum™, Polygon™, Cardano™, and Bitcoin™. Different software applications (e.g., games, financial applications, etc.) may originate the transactions in the blockchain. These applications may run on a cloud network, originating transactions, and broadcasting them for verification to the blockchain network, which verifies and adds the transactions sequentially to the blockchain. Each blockchain network may support a different type of blockchain, differentiated, for example, by the format of the data structures representing each transaction and the function calls that perform actions on the data structures.

Generally, blocks in the blockchain may be associated with a data structure called a token. Certain tokens, such as cryptocurrency are fungible tokens, whereas certain others are NFTs (NFTs). The NFT acts as an irrevocable digital certificate of ownership and authenticity for a unique digital or physical asset, such as a piece of art, digital content, media, and event tickets. The tokens, whether fungible or non-fungible, are created and managed by contracts in the blockchain. The contract is code that is executed deterministically in the blockchain network; each node in the network validates the state-changing operations that the contract's code makes. The contract is generally identified by its contract address, which is assigned to the contract at the time it is generated in the blockchain network. For example, the contract address on the Ethereum network is a 20-byte hexadecimal string that is generated using a hash function. Other blockchains may use different formats or values to identify contracts.

Typically, the contract “mints” a token by executing a function that assigns the token to a particular owner, identified by a specific address in the blockchain network. A single contract having suitable variables, functions, and data structures, may be used to mint multiple tokens according to particular rules for token transfer and management. Each token thus minted will have a separate token ID within the contract. The token is stored in the contract as a data structure that maps the particular token ID to the corresponding blockchain address to which it has been assigned. The blockchain address serves as the owner ID of the token. When the token is transferred or traded, the token's data structure is updated on the blockchain to reflect the new ownership or transfer to a new owner ID.

A user may use a blockchain wallet to store the user's tokens. The blockchain wallet is code that runs on the blockchain network, functioning as a digital account to manage tokens by storing and tracking, for example, private and public keys and transactions associated with the user's network credentials (e.g., private keys, public keys) on the blockchain network. In cases where the token is transferred to the user's wallet, the owner ID of the token may be the public key of the wallet, which is also the wallet's address on the blockchain. The private key of the user is necessary to move content out of the wallet.

Blockchain wallets may be generally categorized into two types: online and offline. Online wallets, of which “public wallets” are examples, are typically software based and implemented by an application running on a computing device (e.g., desktop computer, mobile device, etc.) coupled to the Internet. Some such software wallets may be full-weight wallets that execute entirely on a single computing device; other such software wallets may be lightweight wallets that have a frontend executing on one computing device (such as a smartphone) and a backend executing on another, remote computing device (such as a server). Offline wallets, sometimes referred to as “cold storage”, are generally implemented on a hardware device (e.g., a drive, Universal Serial Bus (USB) stick, etc.) that is disconnected from the Internet when not in use. Cold storage wallets therefore provide extra security by significantly reducing the chances of hacking or malware.

In a public blockchain network, all data in the blockchain is potentially visible to anyone. Determining whether, for example, an NFT has been transferred between two addresses involves parsing through the blockchain for the token ID of the NFT. Addresses associated with a transaction are recorded in the blockchain, but the transactions are regarded as anonymous. That is, there is no identifier of who owns or controls the address. Determining who owns a specific address with access to and control of the address requires more information. For example, a user may claim to own an NFT at a particular wallet address. A third-party (e.g., venue authenticator seeking verification of an NFT digital ticket, etc.) who wants to verify the ownership may parse the blockchain using a blockchain explorer or tool such as Etherscan™, OpenSea™ or Rarible™. This verifies that the NFT is associated with the particular wallet address. Determining that the user is the owner of the wallet address usually requires the user to create a signed transaction with the user's private key and to share that transaction with the third-party. For online wallets this is usually not an inconvenience. But cold storage wallets require them to be online to perform such a transaction, because creating and signing a transaction to verify that the user owns the cold storage cannot happen while the cold storage is offline.

In general in such blockchain networks, NFTs can provide a secure, transparent, and efficient way of issuing and managing entry credentials, such as tickets. NFT tickets have several advantages over conventional paper or simple digital tickets such as QR-codes. NFTs may ensure that the ticket is valid and cannot be counterfeited because they are unchangeable and impossible to reproduce. Their existence as tokens in a blockchain makes it easy to trace their ownership and authenticity. NFT ticketing also enables greater customization and adaptability in terms of ticketing. For example, event organizers may issue different NFTs for separate event sections, such as “VIP” and “general admission” tickets. These tickets can also grant ticketholders access to fan clubs made up only of holders of similar NFT tickets. In such fan clubs and other exclusive events, it may sometimes be desirable to exhibit patrons' individual NFTs at entry, for example, to advertise the ticketholder's presence, status, rewards, awards, or other credentials.

NFT ticketing typically involves the following steps: (1) Creation: Using blockchain technology, an event organizer creates an NFT ticket. Since the ticket is one of a kind, no other item may replace it. (2) Sale: The public purchases NFT tickets via the event organizer's marketplace. (3) Verification: A ticketholder's NFT ticket is scanned using blockchain technology to verify the ticket's bona fides. (4) Access: Access is given to the ticketholder after the ticket has been verified. While the process works in theory, practical implementation has been not satisfactorily effective due to the risk of certain network security vulnerabilities such as man-in-the-middle attacks that can seize user wallets and thereby gain access to the user's digital assets. Security is also a concern as scammers can produce fraudulent NFT tickets (e.g., that are not minted by the event organizers) and sell them to unwary customers. Further, entirely digital verification can be challenging for human ushers at live events who may have no way of knowing whether a ticketholder's ticket is officially verified by the blockchain or whether such verification has been obtained fraudulently. For example, gatecrashers may illegally duplicate a static verification message screen from another valid ticketholder's device.

Accordingly, combining the requirement for security along with need to lessen the burden on ticket-checkers, bouncers, and ushers at entry points (e.g., club doors, event portals, etc.), a system and method for NFT ticketing is disclosed herein that, after verifying an NFT ticket is within a user's wallet, synchronously displays a combination of NFT images and random animations on two screens in an animated synchronicity scheme. The synchronized display facilitates simple visual confirmation by a verifying party, such as a human operator (e.g., ticket checker, bouncer, or usher), reducing human error, and improving security.

A server may receive a request from a wallet application through a ticketholder-device to verify entry credentials of a ticketholder using a first wallet address in the blockchain network. Thereupon, the server may query blockchain data using the first wallet address to identify one or more NFTs at the first wallet address. The server may verify the identified NFT(s) by comparing the identified NFT(s) with a list of pre-approved NFTs stored at the server. All the verified NFTs are then displayed to the user for selection using retrieved digital images corresponding to the verified NFTs. The user may select one of the displayed digital images and the user's selection is transmitted to the server. In some embodiments, the server may randomly select an animation from a repository of animation files. The server may overlay the selected digital image over the randomly selected animation to generate a unique combination. In some other embodiments, the server may randomly select another digital image from a repository of digital image files. The server may overlay the selected digital images to generate a unique combination. In some other embodiments, the server may not combine the digital image representative of the NFT (e.g., unaltered, or altered in some way, such as cropped, rotated, etc.) with any other digital image or animation. The server may thereafter transmit the combination (or only the digital image representative of the NFT) simultaneously to the ticketholder-device and to a verification device (e.g., with a display screen located at the entry portal) such that the ticketholder-device and the verification device synchronously display the combination. The verifying party (e.g., ticker-checker, bouncer, or usher) can easily visually confirm that the combination of the animation and the digital image displayed simultaneously in the ticketholder-device and the verification device are synchronous and identical and authorize the entry credentials of the ticketholder-device/ticketholder.

In some embodiments, where the NFT is stored in a second wallet, the server may also identify parity-tokens at the first wallet address indicative of the existence of NFTs at the second address. Thereupon, the server may query blockchain data of the second wallet address to identify the NFT to be verified at the second wallet address. Linking wallets using parity-tokens can eliminate the need for all but one of the linked wallets to be connected to the blockchain network. Wallets may be linked using tokens entangled together by certain shared token attributes. NFTs are entangled, and parity established, via a series of specific transactions in the blockchain network. These “parity-tokens” are minted simultaneously from a single contract for this purpose. They are indivisible, unique, yet equal NFTs that share certain token attributes, such as at least the contract address, so that different wallets containing these parity-tokens can be linked together based on their “entangled” shared attributes. Thus, wallets linked using parity-tokens can eliminate the need for cold storage wallets and similar other restricted access wallets to be online and/or communicatively coupled to the blockchain network for validating digital assets therein, including entry credentials in the form of NFT tickets.

In some embodiments, an event organizer, using an appropriate software application, may initially generate a digital ticket in the blockchain network, for example, represented by a QR-code or a barcode. The digital ticket may be associated with the list of pre-approved NFTs that serve as entry credentials. A ticketholder may purchase the digital ticket (e.g., in a marketplace), whereupon the digital ticket is sent to the ticketholder-device. The digital ticket may be transferred to the first wallet address of the ticketholder either at the time of purchase or later. The digital ticket may be scanned at an event portal or other entry point from a first wallet interface of the ticketholder-device, triggering the request to the server for verification.

Each of the structures, methods, and systems of the present disclosure may have several innovative aspects, no single one of which is solely responsible for all the desirable attributes disclosed herein. Details of one or more implementations of the subject matter described in this specification are set forth in the description below and the accompanying drawings.

In the following detailed description, various aspects of the illustrative implementations may be described using terms commonly employed by those skilled in the art to convey the substance of their work to others skilled in the art.

The term “connected” means a direct connection (which may be one or more of a communication, mechanical, and/or electrical connection) between the things that are connected, without any intermediary devices, while the term “coupled” means either a direct connection between the things that are connected, or an indirect connection through one or more passive or active intermediary devices.

The term “computing device” means a server, a desktop computer, a laptop computer, a smartphone, or any device with a microprocessor, such as a central processing unit (CPU), general processing unit (GPU), or other such electronic component capable of executing processes of a software algorithm.

The term “cloud network” means a network of computing devices coupled together in a public, private, or hybrid communications network. Communication in the cloud network may use one or more wired, wireless, broadband, radio, and other kinds of communicative means. The Internet is an example of a cloud network. A subset of the computing devices in the cloud network may be employed in the blockchain network, for example, to participate in and/or validate transactions of the blockchain.

The description uses the phrases “in an embodiment” or “in embodiments,” which may each refer to one or more of the same or different embodiments.

Although certain elements may be referred to in the singular herein, such elements may include multiple sub-elements. For example, “a computing device” may include one or more computing devices.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

In the following detailed description, reference is made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

In the drawings, same reference numerals refer to the same or analogous elements shown so that, unless stated otherwise, explanations of an element with a given reference numeral provided in context of one of the drawings are applicable to other drawings where element with the same reference numerals may be illustrated. Further, the singular and plural forms of the labels may be used with reference numerals to denote a single one and multiple ones respectively of the same or analogous type, species, or class of element.

Note that in the figures, various components are shown as aligned, adjacent, or physically proximate merely for ease of illustration; in actuality, some or all of them may be spatially distant from each other. In addition, there may be other components, such as routers, switches, antennas, communication devices, etc. in the networks disclosed that are not shown in the figures to prevent cluttering. Systems and networks described herein may include, in addition to the elements described, other components and services, including network management and access software, connectivity services, routing services, firewall services, load balancing services, content delivery networks, virtual private networks, etc. Further, the figures are intended to show relative arrangements of the components within their systems, and, in general, such systems may include other components that are not illustrated (e.g., various electronic components related to communications functionality, electrical connectivity, etc.). The accompanying drawings are not necessarily drawn to scale.

In the drawings, a particular number and arrangement of structures and components are presented for illustrative purposes and any desired number or arrangement of such structures and components may be present in various embodiments.

Further, unless otherwise specified, the structures shown in the figures may take any suitable form or shape according to various design considerations, manufacturing processes, and other criteria beyond the scope of the present disclosure.

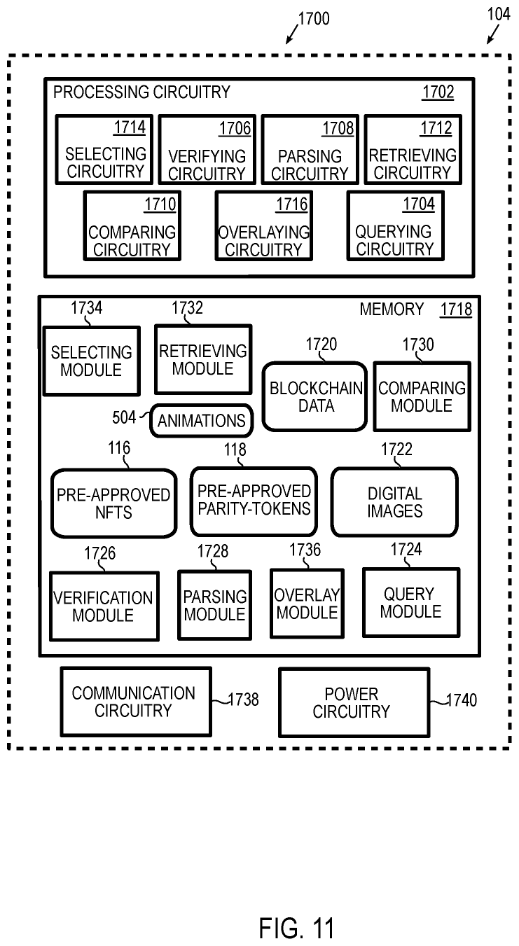

For convenience, if a collection of drawings designated with different letters are present (e.g., FIGS. 11A-11G), such a collection may be referred to herein without the letters (e.g., as “FIG. 11”). Similarly, if a collection of reference numerals designated with different letters are present (e.g., 106a, 106b), such a collection may be referred to herein without the letters (e.g., as “106”) and individual ones in the collection may be referred to herein with the letters. Further, labels in upper case in the figures (e.g., 106A) may be written using lower case in the description herein (e.g., 106a) and should be construed as referring to the same elements.

Various operations may be described as multiple discrete actions or operations in turn in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

### Example Embodiments

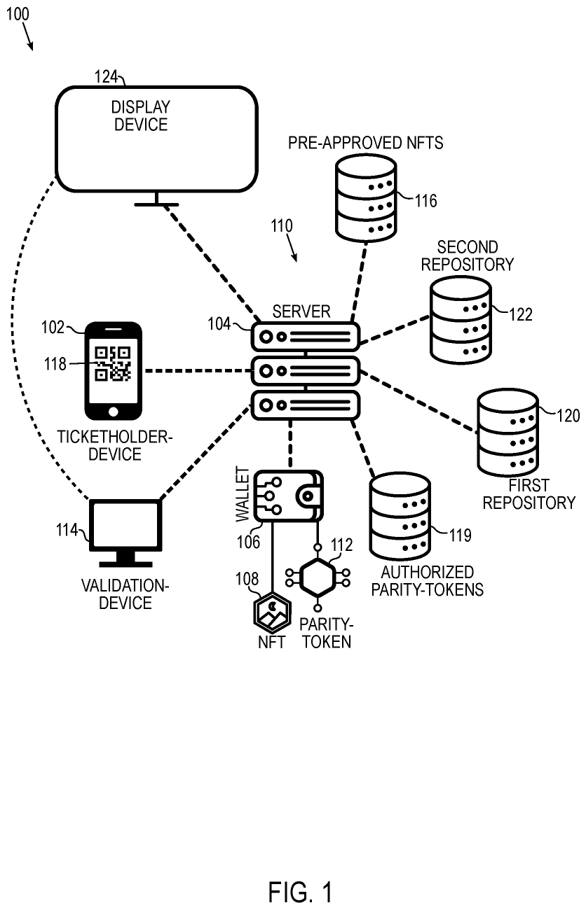

FIG. 1 is a schematic block diagram of an example system 100 according to some embodiments of the present disclosure. System 100 may include a ticketholder-device 102, a server 104, and a wallet 106 holding an NFT 108 in a blockchain network 110. Blockchain network 110 may be any type of public, private, or hybrid blockchain network, including Ethereum™, Polygon™, etc. within the broad scope of the embodiments. In some embodiments, wallet 106 may include instead of, or in addition to, NFT 108, a parity-token 112. Wallet 106 may comprise any suitable type of wallet (i.e., software, hardware, etc.) within the broad scope of the embodiments. In some embodiments, wallet 106 may be a public wallet (e.g., an online wallet). In other embodiments, both wallet 106 may be a cold storage wallet.

In various embodiments, wallet 106 may be accessed through any suitable wallet application, such as MetaMask™, Zengo™, Electrum™, etc. within the broad scope of the embodiments. The wallet application may be standalone applications executing in ticketholder-device 102 entirely (e.g., full-weight wallets) in some embodiments. In other embodiments, the wallet application may be lightweight applications with a frontend at ticketholder-device 102 and a backend at a server (not necessarily server 104) in the cloud network. In some embodiments, the wallet application may be browser plugins configured to execute in any type of computing device suitably, for example, in a smartphone, or desktop computer. In embodiments wherein cold storage wallets are used, the wallet application may be encoded in the hardware devices suitably. In some such embodiments, a client interface may execute in ticketholder-device 102 and a backend may execute in the hardware device.

Server 104 may comprise any suitable computing device, including a plurality of servers, or virtual machines in a cloud network, or other suitable infrastructure configured to perform various operations as described herein. Ticketholder-device 102 may be a smartphone or other suitable computing device that permits the user to communicatively couple to blockchain network 110. In some embodiments, a wallet application (such as MetaMask™) executing in ticketholder-device 102 may facilitate coupling wallet 106 to server 104 suitably.

Ticketholder-device 102 may allow server 104 to communicatively couple to wallet 106 with a signed transaction in blockchain network 110. In various embodiments, the signed transaction may be signed from ticketholder-device 102 using a private key of wallet 106, authenticating the signer as one who has access to and control of wallet 106. The signed transaction may include a wallet address of wallet 106. The wallet address serves as a network identifier of wallet 106 in blockchain network 110. In some embodiments, the wallet address is a hexadecimal hash. Any suitable unique network identifier may be used for the wallet address within the broad scope of the embodiments.

In various embodiments, a validation-device 114 may be communicatively coupled to server 104 prior to validating any electronic tickets. Validation-device 114 may be a desktop computer, a laptop computer, a ticket-scanner, a smartphone, or other suitable computing device that permits validation-device 114 to communicatively couple to blockchain network 110. A suitable application, such as a browser executing in validation-device 114 may be used to upload pre-approved NFTs to a list 116 of pre-approved NFTs in server 104. List 116 may comprise the contract addresses of corresponding pre-approved NFTs in some embodiments. In some other embodiments, list 116 may comprise some other unique token identifiers of corresponding pre-approved NFTs. The pre-approved NFTs may correspond to one or more electronic ticket 118. Electronic ticket 118 may comprise a QR-code in some embodiments. In some other embodiments, electronic ticket 118 may comprise a barcode. Electronic ticket 118 may be of any suitable type and/or format based on particular needs. Validating electronic ticket 118 may include verifying that the ticketholder holds an NFT from list 116 of pre-approved NFTs.

In various embodiments, ticketholder-device 102 may acquire electronic ticket 118 by purchase from a blockchain marketplace. Ticketholder-device 102 may scan electronic ticket 118 as a first step for validating electronic ticket 118. In embodiments wherein electronic ticket 118 is for an event, the scanning may be performed at the event gate. Electronic ticket 118 may be displayed in a user-interface of a wallet application in ticketholder-device 102 in some embodiments.

Electronic ticket 118 facilitates connecting server 104 to wallet 106. For example, in some embodiments, scanning electronic ticket 118 may send a request from the wallet application in ticketholder-device 102 to server 104 for validating electronic ticket 118. Upon receiving the request, server 104 may request a wallet address of wallet 106, for example, through the wallet application that sent the request. Server 104 may inspect the contents of wallet 106, for example, by querying blockchain data based on the wallet address received in the validation request. In embodiments wherein wallet 106 holds NFT 108, server 104 may compare an NFT identifier (such as contract address) of NFT 108 with identifiers in list 116 of pre-approved NFTs. In some embodiments, wallet 106 holds parity-token 112, indicating the existence of a linked wallet as disclosed in U.S. Patent Application titled SYSTEMS AND METHODS FOR LINKING BLOCKCHAIN WALLETS VIA ENTANGLED PARITY-TOKENS, filed concurrently herewith, and which is incorporated by reference herein in its entirety. In some such embodiments, server 104 may identify parity-token 112 by comparing a token identifier (such as contract address) of parity-token 112 with identifiers in another list 119 of pre-authorized parity-tokens. Thereafter, using information obtained from parity-token 112, server 104 may identify another wallet address holding NFT 108, and then compare the NFT identifier with identifiers in list 116 of pre-approved NFTs.

In some embodiments, server 104 may find substantially all NFTs 108 held at wallet 106 or at another wallet linked to wallet 106 by parity-token 112 that match with one or more NFTs in list 116 of pre-approved NFTs. Server 104 may access a first repository 120, retrieve digital images corresponding to NFTs 108 and present the digital images for selection in the user-interface of the wallet application executing in ticketholder-device 102. The ticketholder may select an appropriate image from the selection. Server 104 may access a second repository 122 of animations that are different from each other (i.e., each animation is different from all other animations in second repository 122), select a random one of animation files in second repository 122, and generate a combination of the selected animation file and the digital image. Server 104 may transmit the combination to ticketholder-device 102 and a display device 124 simultaneously such that the combination is synchronously displayed in a screen of ticketholder-device 102 and display device 124. In some embodiments, server 104 may transmit the combination to validation-device 114, which may send it to display device 124. The synchronous display of the unique combination of the selected animation and digital image overlay confirms to a validating party such as a human observer, that ticketholder-device 102 has appropriate entry credentials, thereby validating electronic ticket 118.

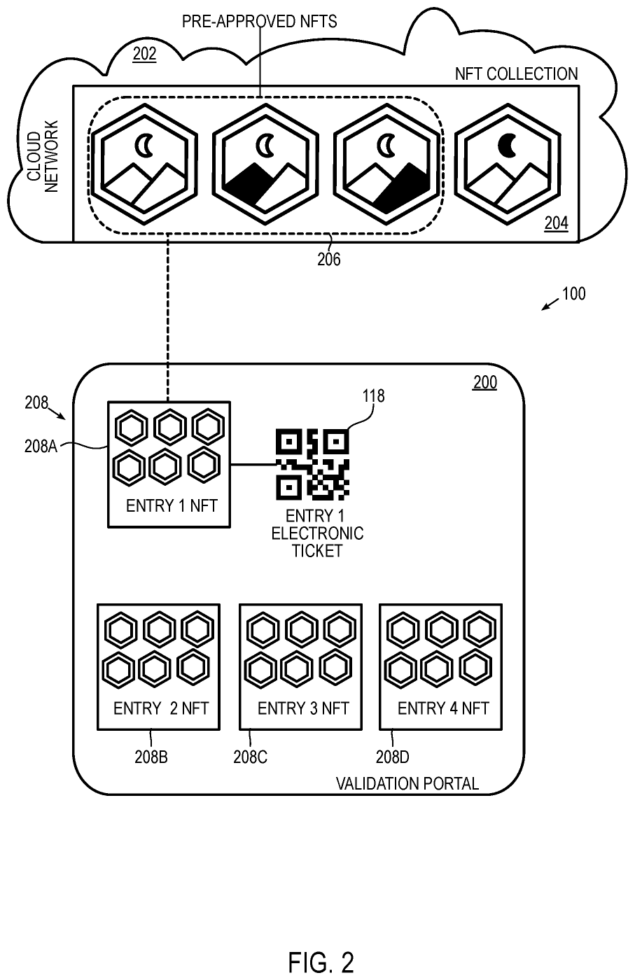

FIG. 2 is a simplified block diagram of an example user-interface 200 in system 100. User-interface 200 may correspond to a validation portal displayed on an appropriate display device communicatively coupled to validation-device 114 in some embodiments. In some other embodiments, user-interface 200 may correspond to the validation portal displayed on an appropriate display device communicatively coupled to a cloud network 202. In some embodiments, user-interface 200 may be part of an application executing entirely in validation-device 114. In some other embodiments, user-interface 200 may be part of an application executing partially in validation-device 114 and partially in a server in cloud network 202.

An NFT collection 204 may be stored in cloud network 202. In some embodiments, NFT collection 204 may be in a distributed storage across blockchain network 110. User-interface 200 may facilitate downloading one or more pre-approved NFTs 206 from NFT collection 204 for a particular set of entry credentials 208 (e.g., 208a “entry 1”). In some embodiments, substantially all NFTs in NFT collection 204 may be pre-approved so that they are among one or more pre-approved NFTs 206. In other embodiments, a subset of NFTs in NFT collection 204 may be comprised in one or more pre-approved NFTs 206.

In some embodiments, for example, where an event organizer has many different events with correspondingly different entry credentials, user-interface 200 may facilitate display of other sets of entry credentials 208b, 208c, 208d, etc. Some such displayed entry credentials 208 may be for entries have occurred in the past, or concurrently occurring, or planned for the future relative to entry for entry credentials 208a. In some embodiments, each set of entry credentials 208 may correspond to a different one in one or more pre-approved NFTs 206. In some embodiments, more than one NFT collection 204 may correspond to a particular one of entry credentials 208.

In various embodiments, user-interface 200 comprising the validation portal may facilitate generating electronic ticket 118 from entry credentials 208. In some embodiments wherein electronic ticket 118 is a QR-code, any available QR-code generator, including browser-based plugins may be used to generate electronic ticket 118 from entry credentials 208. In some embodiments, electronic ticket 118 may comprise information to a specific website or uniform resource locator (URL) of an application communicatively coupled to server 104 such that scanning electronic ticket 118 generates a query by the application to server 104 requesting validation.

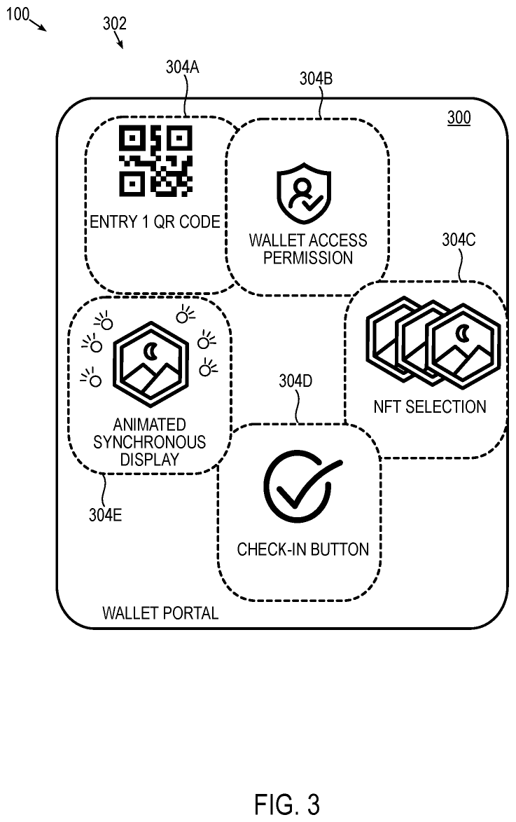

FIG. 3 is a simplified block diagram of an example user-interface 300 that may be associated with wallet 106 in system 100. In various embodiments, user-interface 300 may correspond to a wallet portal executing at least partially in ticketholder-device 102. User-interface 300 may include various display formats 302, for example, windows 304a-304e. In some embodiments, for example, as shown, display formats 302 may be windows that open automatically on a display device. In other embodiments, display formats 302 may be icons that may be selected for more prominent and/or detailed display on the display device. Various other design possibilities may exist for the same display functionality within the broad scope of the embodiments.

In an example, window 304a may display electronic ticket 118. Scanning electronic ticket 118 facilitates connecting ticketholder-device 102 with server 104. Window 304b may facilitate providing permission to the wallet application to send the wallet address of wallet 106 to server 104. For example, a selectable button may be displayed in window 304b, and selecting the button may send the wallet address to server 104. Window 304c may display images of one or more ones of NFT 108 that match with one or more in list 116 of pre-approved NFTs. In an example embodiment, NFT 108 may be represented by a digital image retrieved by server 104 from first repository 120 and transmitted to user-interface 300 by server 104. Several such digital images corresponding to different ones of NFT 108 may be presented for selection in window 304c. Clicking on one of the digital images may send a message to server 104 with information about the selected digital image, for example, the token identifier of NFT 108. Window 304d may present a selectable button that, upon selection, informs server 104 to proceed with the check-in process, for example, with a request for entry. Upon receiving the check-in request, server 104 may randomly select an animation from second repository 122, retrieve a copy of the selected digital image (e.g., selected in window 304c) from first repository 120, overlay the digital image over the animation to generate a combination, and transmit the combination simultaneously to user-interface 300 executing in ticketholder-device 102 and to display device 124. Window 304e may display the combination of animation and digital image transmitted by server 104.

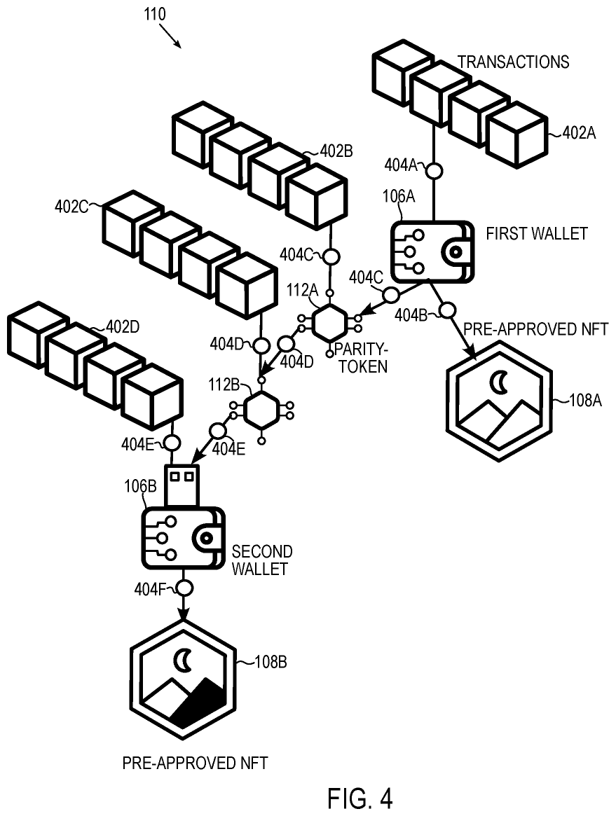

FIG. 4 is a simplified block diagram of various elements in system 100, operations upon which may be performed by server 104 according to some embodiments. In some embodiments, transactions 402a in blockchain network 110 may be associated with a blockchain address 404a corresponding to the wallet address of first wallet 106a. A query of blockchain data based on blockchain address 404a may return transactions 402a. Transactions 402a may be parsed to identify a blockchain address 404b corresponding to the contract address (or another token identifier) of NFT 108a. Blockchain address 404b may be compared with addresses in list 116 of pre-approved NFTs. If a match is found, a digital image representative of NFT 108a may be retrieved by server 104 for further operations. In some embodiments, NFT 108a may be absent in first wallet 106a, or NFTs in first wallet 106a may not be among the list of pre-approved NFTs.

In some embodiments, transactions 402a may be parsed to identify a blockchain address 404c corresponding to the contract address (or another token identifier) of parity-token 112a. A query of blockchain data based on blockchain address 404c may return transactions 402b. Transactions 402b may be parsed to identify a blockchain address 404d of a second wallet 106b in some embodiments. In some other embodiments, transactions 402b may be parsed to identify a blockchain address 404d of a twin parity-token 112b sharing a common identifier such as contract address and minting transaction identifier with parity-token 112a. Twin parity-token 112b may be identified in some embodiments by searching for a minting transaction of parity-token 112a in transactions 402b. As parity-tokens 112a and 112b are minted in a single transaction from a common contract, both parity-tokens 112a and 112b share the contract address and transaction identifier of the minting operation. A query of blockchain data based on blockchain address 404d may return transactions 402c. Transactions 402c may be parsed to identify a blockchain address 404e of a second wallet 106b in some embodiments.

A query of blockchain data based on blockchain address 404e may return transactions 402d. Transactions 402d may be parsed to identify blockchain address 404e of another NFT 108b in second wallet 106b. Blockchain address 404e may be compared with addresses in list 116 of pre-approved NFTs. If a match is found, a digital image representative of NFT 108b may be retrieved by server 104 for further operations. In some embodiments, NFT 108b may be absent in second wallet 106b, or NFTs in second wallet 106b may not be among the list of pre-approved NFTs. The operations may be repeated for all linked wallets until substantially all possible matches with pre-approved NFTs are found.

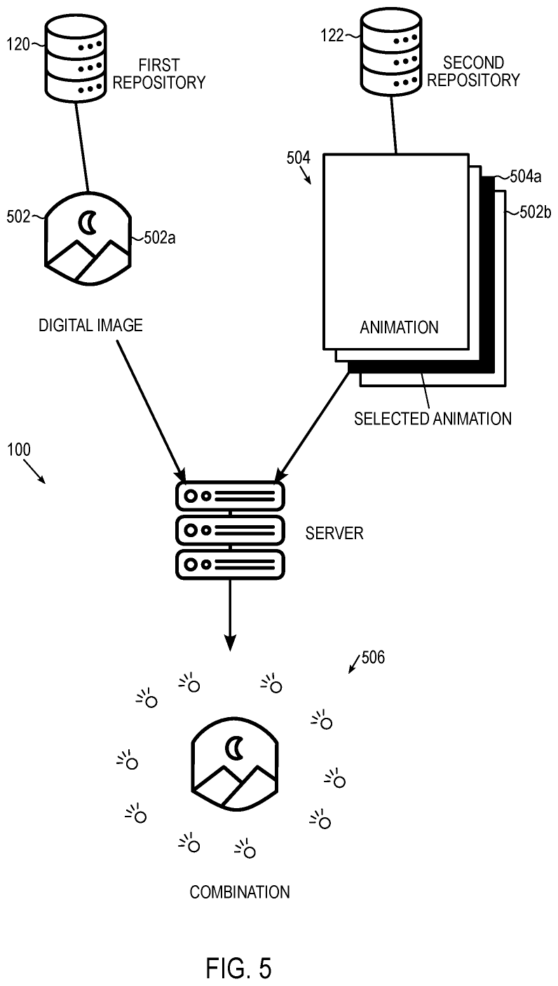

FIG. 5 is a simplified block diagram showing example display operations in system 100 according to some embodiments. After a selection of one of NFT 108 is received by server 104, server 104 may retrieve a digital image 502 (or first digital image 502a) representative of the selection from first repository 120. In some embodiments, digital image 502 may comprise artwork substantially similar to the artwork of NFT 108. In some embodiments, digital image 502 may have a one-to-one correlation with NFT 108. In some other embodiments, digital image 502 may be a generic image having no correlation with the artwork of NFT 108. In some other embodiments, digital image 502 may comprise text (e.g., “VIP”, “it's a match,” etc.). In some other embodiments, some digital images 502 may comprise text, some others may have a one-to-one correlation with NFT 108, and some others may be generic images. In some embodiments, first repository 120 may be internal to server 104. In some other embodiments, first repository 120 may be external to server 104, for example, an NFT marketplace such as OpenSea™. In some other embodiments, first repository 120 may be a temporary storage for temporarily storing digital images retrieved from the external repository.

Server 104 may randomly select an animation 504a from a plurality of animations 504 in second repository 122. Each one of animations 504 is different content-wise (that is, different in content) from all other animations 504. For example, one animation may have a different color palette than other animations; one animation may have a different animation technique than other animations; one animation may have a different time varying content than other animations; and so on. In some embodiments, animations 504 are generic animations. In some other embodiments, animations 504 are customized animations, for example, containing brand logos, trade dress colors and/or other imagery having certain desired semantics (e.g., identifying a particular company, personality, locality, sporting team, etc.). In some other embodiments, a greater number of animations 504 in second repository 122 may correspond to proportionally higher security.

In some embodiments, second repository 122 may comprise static digital images in addition to, or instead of, animations 504. Each one of digital images may be different content-wise (that is, different in content) from all other digital images in second repository 122. In some such embodiments, server 104 may randomly select a second digital image 502b from second repository 122. In some embodiments, second digital image 502b may be a generic digital image (e.g., without distinguishing or special features, for example, purchased from stock digital images available commercially on the Internet). In some embodiments, second digital image 502b may be a static representation of any one of animations 504 (e.g., animation 504a). In some other embodiments, second digital image 502b may be a customized digital image, for example, including brand logos, trade dress colors and/or other imagery having certain desired semantics (e.g., identifying a particular company, personality, locality, sporting team, etc.). In yet other embodiments, second digital image 502b may be a solid color swatch. In some other embodiments, second digital image 502b may be a transparent swatch (e.g., having a transparent background), so that it is not visually apparent when another image is overlaid on it.

Server 104 may generate a combination 506 comprising selected animation 504a and digital image 502. In embodiments wherein server 104 retrieves first digital image 502a from first repository 120 and second digital image 502b from second repository 122, combination 506 may comprise some suitable combination of first digital image 502a and second digital image 502b. In some embodiments, server 104 may not retrieve animation 504a or second digital image 502b from second repository 122. In some such embodiments, combination 506 may not be generated. In some embodiments, combination 506 may comprise an overlay of digital image 502 (or first digital image 502a) over selected animation 504a (or second digital image 502b). Because animation 504a is randomly selected, and NFT 108 is selected by the user, it is unlikely that another ticketholder-device 102b (not shown) going through the same check-in process will get transmitted the same combination 506. Thus, combination 506 may be hackproof (e.g., secure, protected from hackers, etc.) to the extent that it cannot be duplicated by another computing device that is not server 104 for synchronous display at ticketholder-device 102 and display device 124 at the same time.

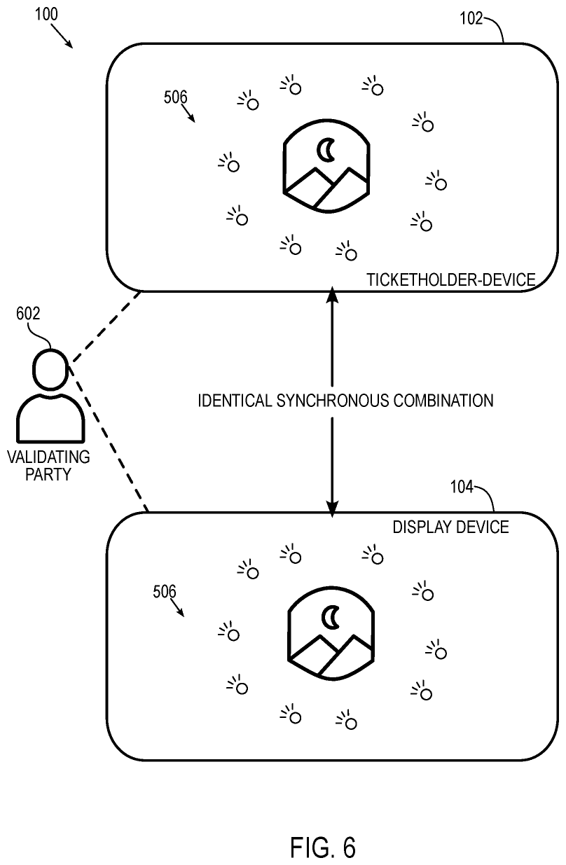

FIG. 6 is a simplified block diagram showing synchronous display at ticketholder-device 102 and display device 124 in system 100 according to some embodiments. In various embodiments, ticketholder-device 102 and display device 124 may synchronously mirror each other's display of combination 506 comprising digital image 502 overlaid on randomly selected animation 504a. In some embodiments, combination 506 may be displayed inside a browser window in ticketholder-device 102 and/or display device 124. Synchronicity of combination 506 displayed in ticketholder-device 102 and display device 124 provides visual confirmation to a validating party 602 (e.g., human observer such as a ticket checker, bouncer, usher, etc.). In some embodiments, validating party 602 may be a camera rather than a human observer. Validating party 602 may allow entry of ticketholder to the event after the visual confirmation.

In various embodiments, any of the features discussed with reference to any of FIGS. 1-6 herein may be combined with any other features to form system 100 for validating electronic ticket 118 in blockchain network 110 as described herein. For example, system 100 as shown in FIG. 1 may be combined with multiple wallets 106 as shown in FIG. 4 in some embodiments. Some such combinations are described above, but, in various embodiments, further combinations and modifications are possible. Various different embodiments described in different figures may be combined suitably based on particular needs within the broad scope of the embodiments.

### Example Methods

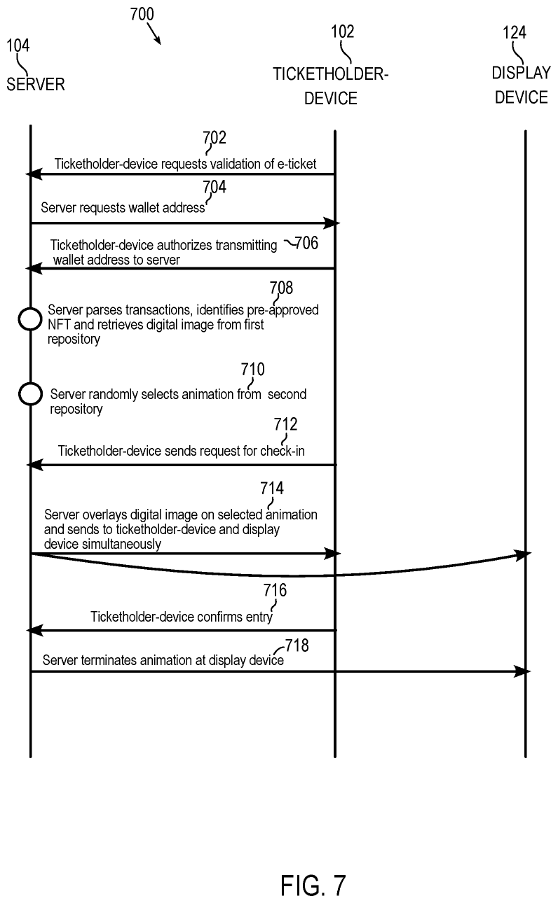

FIG. 7 is a sequence diagram of example operations 700 associated with system 100 according to some embodiments. At 702, ticketholder-device 102 requests validation of electronic ticket 118. In some embodiments, the request may be automatically sent when ticketholder-device 102 scans electronic ticket 118. At 704, server 104 requests wallet address, for example, blockchain address 404a, from the wallet application of wallet 106. In some embodiments, the request may be sent from server 104 to ticketholder-device 102, which may relay the request to the wallet application executing at least partially in cloud network 202. In some other embodiments, the request may be sent from server 104 to the portion of the wallet application executing in ticketholder-device 102. At 706, ticketholder-device 102 authorizes transmitting the wallet address comprising blockchain address 404a to server 104.

At 708, server 104 may parse transactions to identify one or more NFTs 108 pre-approved for entry. In some embodiments, server 104 may query blockchain data based on blockchain address 404a. The query may return transactions 402a. Server 104 may parse transactions 402a to identify blockchain address 404b corresponding to the contract address (or another token identifier) of NFT 108a. Server 104 may compare blockchain address 404b with addresses in list 116 of pre-approved NFTs. If server 104 finds a match, server 104 may retrieve digital image 502 representative of NFT 108a for further operations. In some embodiments, server 104 may parse transactions 402a to identify blockchain address 404c corresponding to the contract address (or another token identifier) of parity-token 112a. Server 104 may query blockchain data based on blockchain address 404c. The query may return transactions 402b. Server 104 may parse transactions 402b to identify blockchain address 404e of a second wallet 106b in some embodiments. In some other embodiments, server 104 may parse transactions 402b to identify blockchain address 404d of twin parity-token 112b sharing a common identifier such as contract address and minting transaction identifier with parity-token 112a. Server 104 may identify twin parity-token 112b by searching for the minting transaction of parity-token 112a in transactions 402b and identifying the tokens minted therein. As parity-tokens 112a and 112b are minted in a single transaction from a common contract, both parity-tokens 112a and 112b share the contract address and transaction identifier of the minting operation. Server 104 may query blockchain data based on blockchain address 404d. The query may return transactions 402c. Server 104 may parse transactions 402c to identify blockchain address 404e of second wallet 106b in some embodiments. Server 104 may query blockchain data based on blockchain address 404e. The query may return transactions 402d. Server 104 may parse transactions 402d to identify blockchain address 404e of another NFT 108b in second wallet 106b. Blockchain address 404e may be compared with addresses in list 116 of pre-approved NFTs. If a match is found, digital image 502 representative of NFT 108b may be retrieved by server 104 for further operations. The operations may be repeated for all linked wallets until substantially all possible matches with pre-approved NFTs are found.

At 710, server 104 may randomly select animation 504a from second repository 122. At 712, ticketholder-device 102 sends a request for check-in. In some embodiments, the request may be sent when a selectable button in the wallet application (or browser) is selected, which causes ticketholder-device 102 to send the request to server 104. At 714, server 104 overlays digital image 502 retrieved in operation 708 with animation 504a selected in operation 710 to generate combination 506. In some embodiments, server 104 may transmit combination 506 simultaneously to ticketholder-device 102 and display device 124. At 716, ticketholder-device 102 may confirm entry, for example, upon a selectable button (e.g., “confirm entry” button) being selected in a user-interface of ticketholder-device 102. At 718, server 104 terminates the display of combination 506 in display device 124. In some embodiments, server 104 may also terminate the display of combination 506 in ticketholder-device 102.

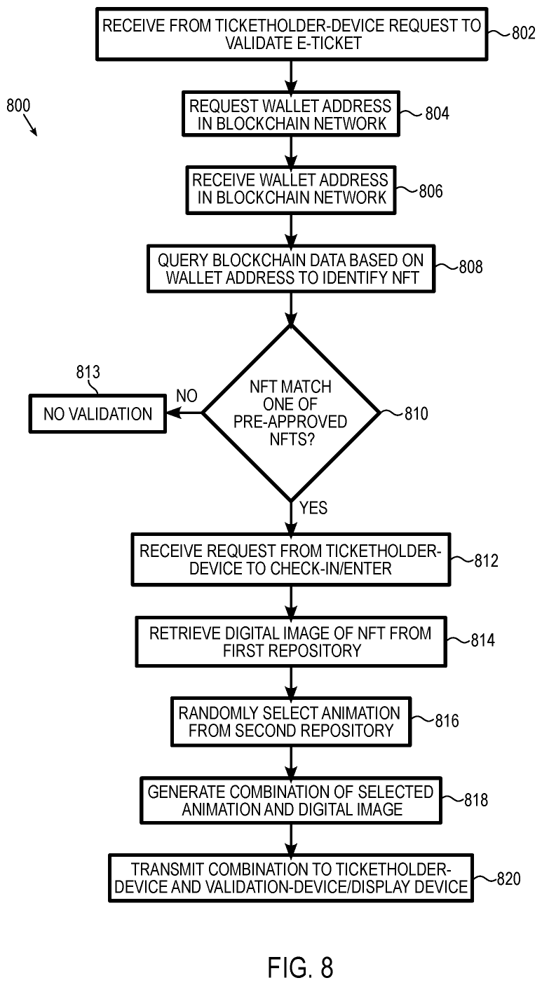

FIG. 8 is a schematic flow diagram showing various operations 800 that may be associated with system 100 according to some embodiments of the present disclosure. At 802, server 104 may receive from ticketholder-device 102 a request to validate electronic ticket 118. In various embodiments, the request may be automatically sent when electronic ticket 118 is scanned by validation-device 114. In some embodiments, the request may be sent from ticketholder-device 102. In some other embodiments, the request may be sent by validation-device 114. In yet other embodiments, the request may be sent by an application executing in cloud network 202 and communicatively coupled with server 104, ticketholder-device 102 and/or validation-device 114.

At 804, server 104 may request the wallet address comprising blockchain address 404a of wallet 106 in blockchain network 110. In some embodiments, the request may be sent to ticketholder-device 102 directly. In some other embodiments, the request may be sent to the wallet application executing in cloud network 202. In some other embodiments, the request may be relayed to ticketholder-device 102 by the wallet application acting as intermediary between server 104 and ticketholder-device 102.

At 806, server 104 may receive the wallet address comprising blockchain address 404a of wallet 106 in blockchain network 110. In some embodiments, the ticketholder-device 102 may give permission to the wallet application to provide the wallet address, and the wallet application may subsequently send the wallet address to server 104. In some other embodiments, the wallet application may send a signed transaction initiated by ticketholder-device 102 to server 104, the signed transaction allowing server 104 to connect to wallet 106 and pull the wallet address therefrom.

At 808, server 104 may query blockchain data based on the wallet address comprising blockchain address 404a to identify NFT 108. The query may return transactions 402a. Server 104 may parse transactions 402a to identify blockchain address 404b corresponding to the contract address (or another token identifier) of NFT 108.

At 810, server 104 may make a determination whether NFT 108 is one of the pre-approved NFTs. In some embodiments, the determination may be made by comparing the contract address (or another token identifier) comprising blockchain address 404b of NFT 108 identified in operation 808 with list 116 of pre-approved NFTs to find a match. If a match is found, then NFT 108 is one of the pre-approved NFTs, and the operations proceed to 812. If a match is not found, then NFT 108 is not one of the pre-approved NFTs, and the operations proceed to 813, with a finding of no validation of electronic ticket 118, terminating the process.

Turning back to 812, server 104 may receive a request from ticketholder-device 102 to check-in/enter. In some embodiments, for example where a long queue awaits the ticketholder before entering the event, electronic ticket 118 may be scanned at the time of entering the queue and the request for check-in may be sent when the ticketholder reaches the portal towards the end of the queue. In such embodiments, there could be a noticeable time lag between the time the request for validation is received by server 104 at 802 and the request for check-in is received by server 104 at 812. In some other embodiments, where there is no such queue, there may not be a noticeable time lag between the time the request for validation is received by server 104 at 802 and the request for check-in is received by server 104 at 812. In some embodiments, server 104 may allow ticketholder-device 102 to request check-in only when a match is found at 810.

At 814, server 104 may retrieve digital image 502 corresponding to NFT 108 from first repository 120. In some embodiments, digital image 502 may comprise artwork substantially similar to the artwork of NFT 108. In some embodiments, digital image 502 may have a one-to-one correlation with NFT 108. In some other embodiments, digital image 502 may be a generic image having no correlation with the artwork of NFT 108. In some other embodiments, digital image 502 may comprise text (e.g., “VIP”, “it's a match,” etc.). In some other embodiments, some digital images 502 may comprise text, some others may have a one-to-one correlation with NFT 108, and some others may be generic images.

At 816, server 104 may randomly select animation 504a from second repository 122. In some embodiments, animation 504a may be a generic animation (e.g., without distinguishing or special features, for example, purchased off stock animations available commercially on the Internet). In some other embodiments, animation 504a may be a customized animation, for example, including brand logos, trade dress colors and/or other imagery having certain desired semantics (e.g., identifying a particular company, personality, locality, sporting team, etc.).

At 818, server 104 may generate combination 506 of selected animation 504a and digital image 502. In some embodiments, combination 506 may comprise digital image 502 overlaid on animation 504a. In some other embodiments, combination 506 may comprise digital image 502 side-by-side with animation 504a. In some other embodiments, combination 506 may comprise an alternating time sequence of animation 504a and digital image 502 (e.g., animation 504a displayed first, followed by digital image 502, and then back to animation 504a, and so on).

At 820, server 104 may transmit combination 506 to ticketholder-device 102 and validation-device 114 and/or display device 124. In some embodiments, server 104 may transmit combination 506 to all devices substantially simultaneously. In some other embodiments, server 104 may transmit combination 506 to all device serially (i.e., one at a time). In some embodiments, server 104 may transmit combination 506 to validation-device 114, which may subsequently transmit it to display device 124. Subsequently, combination 506 may be displayed synchronously at ticketholder-device 102 and display device 124 sufficient for visual confirmation by validating party 602.

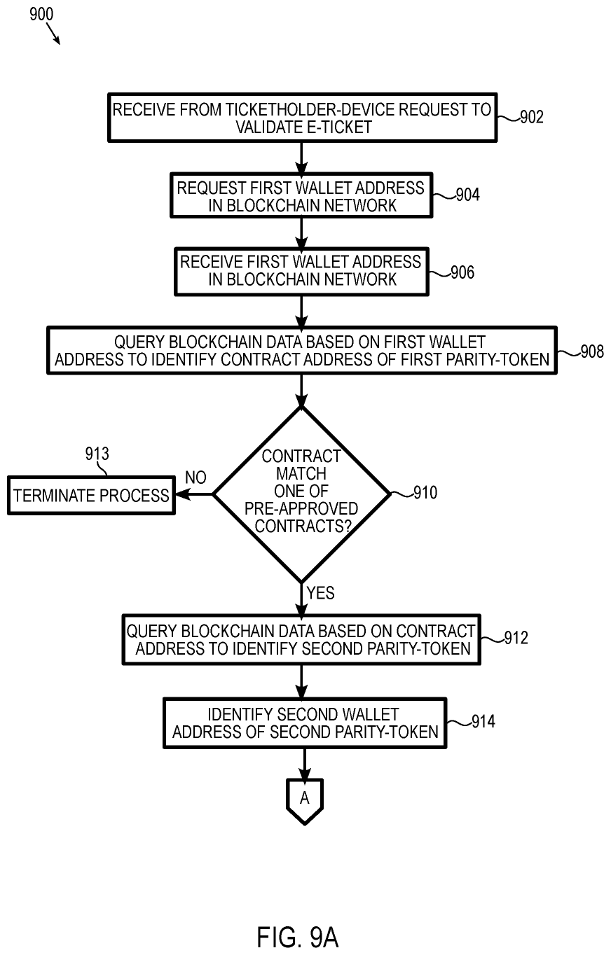

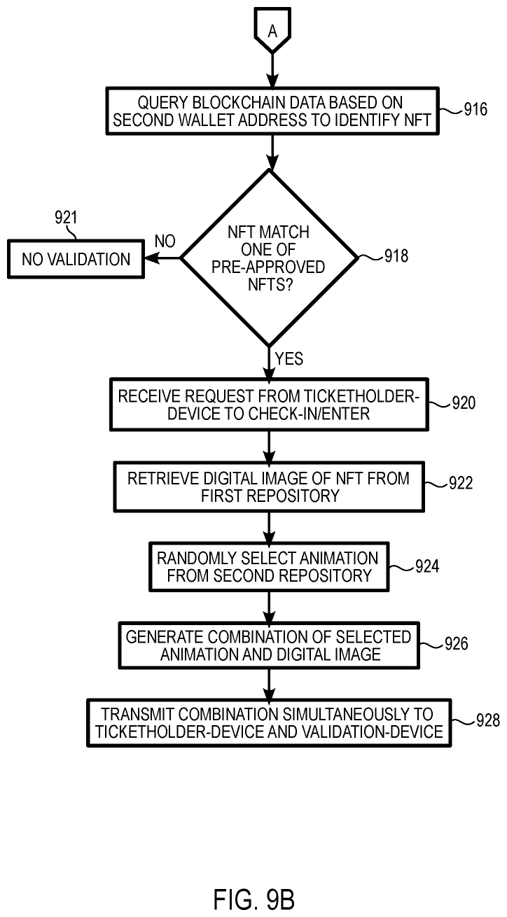

FIGS. 9A-9B are schematic flow diagrams showing various operations 900 in system 100 according to some embodiments of the present disclosure. Note that FIG. 9B is a continuation of the flow chart of FIG. 9A. In FIG. 9A, at 902, server 104 may receive from ticketholder-device 102 a request to validate electronic ticket 118. In various embodiments, the request may be automatically sent when electronic ticket 118 is scanned by validation-device 114. In some embodiments, the request may be sent from ticketholder-device 102. In some other embodiments, the request may be sent by validation-device 114. In yet other embodiments, the request may be sent by an application executing in cloud network 202 and communicatively coupled with server 104, ticketholder-device 102 and/or validation-device 114.

At 904, server 104 may request the wallet address comprising blockchain address 404a of wallet 106 in blockchain network 110. In some embodiments, the request may be sent to ticketholder-device 102 directly. In some other embodiments, the request may be sent to the wallet application executing in cloud network 202. In some other embodiments, the request may be relayed to ticketholder-device 102 by the wallet application acting as intermediary between server 104 and ticketholder-device 102.

At 906, server 104 may receive the wallet address comprising blockchain address 404a of wallet 106 in blockchain network 110. In some embodiments, the ticketholder-device 102 may give permission to the wallet application to provide the wallet address, and the wallet application may subsequently send the wallet address to server 104. In some other embodiments, the wallet application may send a signed transaction initiated by ticketholder-device 102 to server 104, the signed transaction allowing server 104 to connect to wallet 106 and pull the wallet address therefrom.

At 908, server 104 may query blockchain data based on the wallet address comprising blockchain address 404a to identify first parity-token 112a. The query may return transactions 402a. Server 104 may parse transactions 402a to identify blockchain address 404c corresponding to the contract address (or another token identifier) of first parity-token 112a.

At 910, server 104 may make a determination whether first parity-token 112a is one of authorized parity-tokens. In some embodiments, the determination may be made by comparing the contract address (or another token identifier) comprising blockchain address 404c of first parity-token 112a identified in operation 908 with list 119 of pre-approved parity-tokens to find a match. If a match is found, then first parity-token 112a is one of the pre-approved parity-tokens, and the operations proceed to 912. If a match is not found, then first parity-token 112a is not one of the pre-approved parity-tokens, and the operations proceed to 913, terminating the process.

Turning back to 912, server 104 may query blockchain data based on blockchain address 404c of first parity-token 112a. The query may return transactions 402b.

At 914, server 104 may parse transactions 402b to identify blockchain address 404e of a second wallet 106b in some embodiments. In some other embodiments, server 104 may parse transactions 402b to identify blockchain address 404d of twin parity-token 112b sharing a common identifier such as contract address and minting transaction identifier with parity-token 112a. Server 104 may identify twin parity-token 112b by searching for the minting transaction of parity-token 112a in transactions 402b and identifying the tokens minted therein. As parity-tokens 112a and 112b are minted in a single transaction from a common contract, both parity-tokens 112a and 112b share the contract address and transaction identifier of the minting operation. Server 104 may thereafter query blockchain data based on blockchain address 404d. The query may return transactions 402c. Server 104 may parse transactions 402c to identify blockchain address 404e of second wallet 106b.

Continuing to FIG. 9B, at 916, server 104 server 104 may query blockchain data based on the wallet address comprising blockchain address 404e to identify NFT 108b. The query may return transactions 402d. Server 104 may parse transactions 402d to identify blockchain address 404e corresponding to the contract address (or another token identifier) of NFT 108b.

At 918, server 104 may make a determination whether NFT 108b is one of the pre-approved NFTs. In some embodiments, the determination may be made by comparing the contract address (or another token identifier) comprising blockchain address 404e of NFT 108b identified in operation 916 with list 116 of pre-approved NFTs to find a match. If a match is found, then NFT 108b is one of the pre-approved NFTs, and the operations proceed to 920. If a match is not found, then NFT 108B is not one of the pre-approved NFTs, and the operations proceed to 921, with a finding of no validation of electronic ticket 118, terminating the process.

Turning back to 920, server 104 may receive a request from ticketholder-device 102 to check-in/enter. In some embodiments, for example where a long queue awaits the ticketholder before entering the event, electronic ticket 118 may be scanned at the time of entering the queue and the request for check-in may be sent when the ticketholder reaches the portal towards the end of the queue. In such embodiments, there could be a noticeable time lag between the time the request for validation is received by server 104 at 902 and the request for check-in is received by server 104 at 920. In some other embodiments, where there is no such queue, there may not be a noticeable time lag between the time the request for validation is received by server 104 at 902 and the request for check-in is received by server 104 at 920. In some embodiments, server 104 may allow ticketholder-device 102 to request check-in only when a match is found at 918.

At 922, server 104 may retrieve digital image 502 corresponding to NFT 108 from first repository 120. In some embodiments, digital image 502 may comprise artwork substantially similar to the artwork of NFT 108. In some embodiments, digital image 502 may have a one-to-one correlation with NFT 108. In some other embodiments, digital image 502 may be a generic image having no correlation with the artwork of NFT 108. In some other embodiments, digital image 502 may comprise text (e.g., “VIP”, “it's a match,” etc.). In some other embodiments, some digital images 502 may comprise text, some others may have a one-to-one correlation with NFT 108, and some others may be generic images.

At 924, server 104 may randomly select animation 504a from second repository 122. In some embodiments, animation 504a may be a generic animation (e.g., without distinguishing or special features, for example, purchased off stock animations available commercially on the Internet). In some other embodiments, animation 504a may be a customized animation, for example, including brand logos, trade dress colors and/or other imagery having certain desired semantics (e.g., identifying a particular company, personality, locality, sporting team, etc.).

At 926, server 104 may generate combination 506 of selected animation 504a and digital image 502. In some embodiments, combination 506 may comprise digital image 502 overlaid on animation 504a. In some other embodiments, combination 506 may comprise digital image 502 side-by-side with animation 504a. In some other embodiments, combination 506 may comprise an alternating time sequence of animation 504a and digital image 502 (e.g., animation 504a displayed first, followed by digital image 502, and then back to animation 504a, and so on).

At 928, server 104 may transmit combination 506 to ticketholder-device 102 and validation-device 114 and/or display device 124. In some embodiments, server 104 may transmit combination 506 to all devices substantially simultaneously. In some other embodiments, server 104 may transmit combination 506 to one device at a time sequentially. In some embodiments, server 104 may transmit combination 506 to validation-device 114, which may subsequently transmit it to display device 124. Subsequently, combination 506 may be displayed synchronously at ticketholder-device 102 and display device 124 sufficient for visual confirmation by validating party 602.

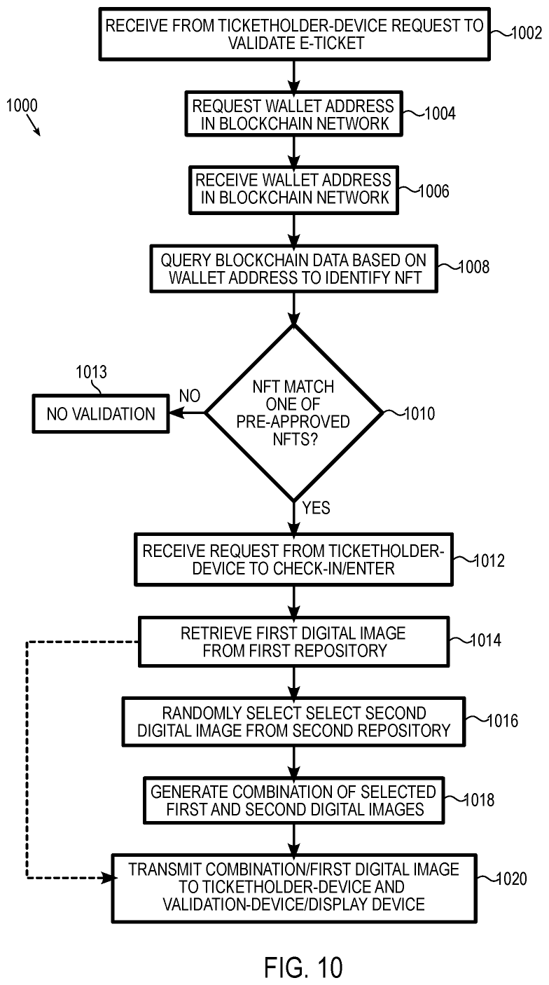

FIG. 10 is a schematic flow diagram showing various operations 1000 that may be associated with system 100 according to some embodiments of the present disclosure. At 1002, server 104 may receive from ticketholder-device 102 a request to validate electronic ticket 118. In various embodiments, the request may be automatically sent when electronic ticket 118 is scanned by validation-device 114. In some embodiments, the request may be sent from ticketholder-device 102. In some other embodiments, the request may be sent by validation-device 114. In yet other embodiments, the request may be sent by an application executing in cloud network 202 and communicatively coupled with server 104, ticketholder-device 102 and/or validation-device 114.

At 1004, server 104 may request the wallet address comprising blockchain address 404a of wallet 106 in blockchain network 110. In some embodiments, the request may be sent to ticketholder-device 102 directly. In some other embodiments, the request may be sent to the wallet application executing in cloud network 202. In some other embodiments, the request may be relayed to ticketholder-device 102 by the wallet application acting as intermediary between server 104 and ticketholder-device 102.

At 1006, server 104 may receive the wallet address comprising blockchain address 404a of wallet 106 in blockchain network 110. In some embodiments, the ticketholder-device 102 may give permission to the wallet application to provide the wallet address, and the wallet application may subsequently send the wallet address to server 104. In some other embodiments, the wallet application may send a signed transaction initiated by ticketholder-device 102 to server 104, the signed transaction allowing server 104 to connect to wallet 106 and pull the wallet address therefrom.

At 1008, server 104 may query blockchain data based on the wallet address comprising blockchain address 404a to identify NFT 108. The query may return transactions 402a. Server 104 may parse transactions 402a to identify blockchain address 404b corresponding to the contract address (or another token identifier) of NFT 108.

At 1010, server 104 may make a determination whether NFT 108 is one of the pre-approved NFTs. In some embodiments, the determination may be made by comparing the contract address (or another token identifier) comprising blockchain address 404b of NFT 108 identified in operation 808 with list 116 of pre-approved NFTs to find a match. If a match is found, then NFT 108 is one of the pre-approved NFTs, and the operations proceed to 1012. If a match is not found, then NFT 108 is not one of the pre-approved NFTs, and the operations proceed to 1013, with a finding of no validation of electronic ticket 118, terminating the process.

Turning back to 1012, server 104 may receive a request from ticketholder-device 102 to check-in/enter. In some embodiments, for example where a long queue awaits the ticketholder before entering the event, electronic ticket 118 may be scanned at the time of entering the queue and the request for check-in may be sent when the ticketholder reaches the portal towards the end of the queue. In such embodiments, there could be a noticeable time lag between the time the request for validation is received by server 104 at 1002 and the request for check-in is received by server 104 at 1012. In some other embodiments, where there is no such queue, there may not be a noticeable time lag between the time the request for validation is received by server 104 at 1002 and the request for check-in is received by server 104 at 1012. In some embodiments, server 104 may allow ticketholder-device 102 to request check-in only when a match is found at 1010.

At 1014, server 104 may retrieve a first digital image 502a corresponding to NFT 108 from first repository 120. In some embodiments, first digital image 502a may comprise artwork substantially similar to the artwork of NFT 108. In some embodiments, first digital image 502a may have a one-to-one correlation with NFT 108. In some other embodiments, first digital image 502a may be a generic image having no correlation with the artwork of NFT 108. In some other embodiments, first digital image 502a may comprise text (e.g., “VIP”, “it's a match,” etc.). In some other embodiments, some first digital images 502a may comprise text, some others may have a one-to-one correlation with NFT 108, and some others may be generic images.

At 1016, server 104 may randomly select a second digital image 502b from second repository 122. In some embodiments, second digital image 502b may be a generic digital image (e.g., without distinguishing or special features, for example, purchased from stock digital images available commercially on the Internet). In some embodiments, second digital image 502b may be a static representation of any one of animations 504 (e.g., animation 504a) in second repository 122. In some other embodiments, second digital image 502b may be a customized digital image, for example, including brand logos, trade dress colors and/or other imagery having certain desired semantics (e.g., identifying a particular company, personality, locality, sporting team, etc.). In yet other embodiments, second digital image 502b may be a blank color swatch, for example, displaying a solid block of color. In some such embodiments, second digital image 502b may have a transparent background, so that it is not visually apparent when another image is overlaid on it.

At 1018, server 104 may generate combination 506 of first digital image 502a and second digital image 502b. In some embodiments, combination 506 may comprise first digital image 502a overlaid on second digital image 502b. In some other embodiments, combination 506 may comprise first digital image 502a side-by-side with second digital image 502b. Any suitable combination of first digital image 502a and second digital image 502b may be included in combination 506 within the broad scope of the embodiments.

At 1020, server 104 may transmit combination 506 to ticketholder-device 102 and validation-device 114 and/or display device 124. In some embodiments, server 104 may transmit combination 506 to all devices substantially simultaneously. In some other embodiments, server 104 may transmit combination 506 to all device serially (i.e., one at a time). In some embodiments, server 104 may transmit combination 506 to validation-device 114, which may subsequently transmit it to display device 124. Subsequently, combination 506 may be displayed synchronously at ticketholder-device 102 and display device 124 sufficient for visual confirmation by validating party 602. In some embodiments, the operations may step from 1014 to 1020 directly, bypassing operations 1016 and 1018. In such embodiments, server 104 may transmit first digital image 502a (and not combination 506) to ticketholder-device 102 and validation-device 114 and/or display device 124 in operation 1020.

Although FIGS. 7-10 illustrate various operations performed in a particular order, this is simply illustrative, and the operations discussed herein may be reordered and/or repeated as suitable. Further, additional operations which are not illustrated may also be performed without departing from the scope of the present disclosure. Also, various ones of the operations discussed herein with respect to FIGS. 7-10 may be modified in accordance with the present disclosure to validate electronic ticket 118 as disclosed herein. Although various operations are illustrated in FIGS. 7-10 once each, the operations may be repeated as often as desired. For example, operations 808 to 812 in FIG. 8 may be repeated for verifying approved status of separate ones of NFT 108 in wallet 106. In another example, operations 908 to 916 in FIG. 9A may be repeated for every parity-token 112 found in first wallet 106a. Likewise, operations 916 to 920 in FIG. 9B may be repeated for verifying approved status of separate ones of NFT 108b in second wallet 106b.

### Example Devices and Components

The methods and systems disclosed herein, e.g., any of the embodiments shown in FIGS. 1-10 or any further embodiments described herein, may be included in any suitable computing device as shown in FIG. 11. FIG. 11 is a simplified block diagram of an example computing device 1700 that may be included in system 100 of any one of FIGS. 1-10 in accordance with any of the embodiments disclosed herein. For example, server 104 includes computing device 1700 in some embodiments. Computing device 1700 may include a processing circuitry (alternatively processing unit) 1702 (e.g., one or more processing devices). As used herein, the term “processing circuitry” or “processing unit” may refer to any device or portion of a device that processes electronic data from registers and/or memory to transform that electronic data into other electronic data that may be stored in registers and/or memory. Processing circuitry 1702 may include one or more digital signal processors (DSPs), Application Specific Integrated Circuits (ASICs), CPUs, GPUs, crypto-processors (specialized processors that execute cryptographic algorithms within hardware), server processors, or any other suitable processing devices.

In various embodiments, processing circuitry 1702 may include various circuitries configured for performing various functions. For example, a querying circuitry 1704 may query blockchain data based on blockchain addresses 404. A verifying circuitry 1706 may verify whether NFT 108 is pre-approved. Verifying circuitry 1706 may use parsing circuitry 1708 and comparing circuitry 1719 to perform certain verification operations. For example, parsing circuitry 1708 may parse transaction 402a to identify blockchain address 404b of NFT 108a; comparing circuitry 1710 may compare blockchain address 404b with list 116 of pre-approved NFTs. If a match is found, verifying circuitry 1706 may send a validation message through communication circuitry 1738.

A processing circuitry 1702 may include retrieving circuitry 1712 that may retrieve digital image 502 and/or animation 504a from appropriate storage as described previously. A selecting circuitry 1714 may select appropriate digital image 502 and/or animation 504a suitably. For example, selecting circuitry 1714 may select digital image 502 after comparing certain image identifiers between digital image 592 and NFT 108 in embodiments where a one-to-one correspondence exists between digital image 502 and NFT 108. An overlaying circuitry 1716 may generate combination 506, for example, by overlaying digital image 502 over animation 504a. Although the various circuitries are shown here as distinct and separate from each other, they may overlap, with components of any one circuitry being used by (e.g., shared with) other circuitries.

Computing device 1700 may include non-transitory computer-readable media coupled to processing circuitry 1702, such as a memory 1718, which may itself include one or more memory devices such as volatile memory such as dynamic random access memory (DRAM), nonvolatile memory (e.g., read-only memory (ROM)), flash memory, solid-state memory, and/or a hard drive. In some embodiments, memory 1718 may include memory that shares a die with processing circuitry 1702. In various embodiments, various data, such as blockchain data 1720 may be stored in memory 1718. In some embodiments, blockchain data 1720 may be stored temporarily, for example, after retrieving from repositories such as OpenSea™. List 116 of pre-approved NFTs may be stored in memory 1718 in some embodiments. List 119 of pre-approved parity-tokens may be stored in memory 1718 in some embodiments. Animations 504 may be stored in memory 1718 (i.e., second repository 122 may be part of memory 1718) in some embodiments. Digital images 1722 may be stored in memory 1718 in some embodiments (i.e., first repository 120 may be part of memory 1718) in some embodiments. Digital images 1722 may comprise digital images 502a and 502b in many embodiments.

Various code for performing various operations as described herein may be stored in memory 1718. Such code and the algorithms expressed by them are shown as modules in FIG. 10. Such modules include query module 1724, verification module 1726, parsing module 1728, comparing module 1730, retrieving module 1732 and selecting module 1734. Various other modules for operations relevant to the functioning of computing device 1700 may be included in memory 1718 within the broad scope of the embodiments.

Query module 1724 comprises instructions for querying blockchain data based on certain query terms, such as blockchain address 404. Any suitable algorithm for querying, such as adaptive spatiotemporal blockchain index method, materializing the data of the blockchain in a standard database format, verifiable Boolean range queries, etc. may be used within the broad scope of the embodiments. In various embodiments, the instructions stored at query module 1724 may be executed by querying circuitry 1704.

Verification module 1726 comprises instructions for evaluating a request against a suitable rule, statements, facts, etc. and related operations. For example, verification module 1726 may evaluate whether NFT 108 is pre-approved for validating electronic ticket 118. In various embodiments, the instructions stored at verification module 1726 may be executed by verifying circuitry 1706.

Parsing module 1728 comprises instructions for parsing transactions 402 to identify blockchain addresses 404 therein. For example, parsing module 1728 may parse transactions 402a to identify blockchain address 404a of NFT 108. Parsing module 1728 may include rules for identifying data types and relevant values, so as to enable parsing module 1728 to identify blockchain addresses 404, etc. in transactions 402. In various embodiments, the instructions stored at parsing module 1728 may be executed by parsing circuitry 1708.

Comparing module 1730 comprises instructions for comparing two terms. In various embodiments, any suitable algorithm for comparing may be used, including Hamming Distance, Levenshtein Distance, Jaro-Winkler, Jaccard Index, Sorensen-Dice, Ratcliff-Obershelp, etc. for string similarity searching. For example, comparing module 1730 may compare blockchain address of NFT 108 in wallet 106 with list 116 of pre-approved NFTs to determine a match. In various embodiments, the instructions stored at comparing module 1730 may be executed by comparing circuitry 1710.

Retrieving module 1732 comprises instructions for retrieving digital image 502 and/or animation 504a from respective repositories for display. The instructions may include rules for selecting digital image 502 and/or animation 504a. For example, retrieving module 1732 may comprise various FETCH( ) functions with conditional IF-THEN-ELSE statements as appropriate. In various embodiments, the instructions stored at retrieving module 1732 may be executed by retrieving circuitry 1712.

Selecting module 1734 comprises instructions for selecting animation 504a from animations 504 in second repository 122. Various algorithms for randomized selection may be included in the instructions of selecting module 1734. Examples include Quicksort, Monte Carlo, partitioning algorithms, recursive algorithms, etc. In various embodiments, the instructions stored at selecting module 1734 may be executed by selecting circuitry 1714.

Overlay module 1736 comprises instructions for generating combination 506 from digital image 502 and animation 504a. Various types of algorithms may be used to generate combination 506 as desired and/or based on particular needs. For example, the instructions may comprise rules for overlaying digital image 502 over animation 504a such that digital image 502 is static whereas animation 504a is animated. In another example, the instructions may comprise rules for overlaying digital image 502 over animation 504a such that digital image 502 is pulsated at the same frequency and synchronously as animation 504a. In various embodiments, the instructions stored at overlay module 1736 may be executed by overlaying circuitry 1716.

In some embodiments, computing device 1700 may include a communication circuitry 1738 coupled to processing circuitry 1702 and comprising one or more communication chips. For example, communication circuitry 1738 may be configured for managing wireless communications for the transfer of data to and from computing device 1700. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

Communication circuitry 1738 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), LTE project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. Communication circuitry 1738 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. Communication circuitry 1738 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication circuitry 1738 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. Communication circuitry 1738 may operate in accordance with other wireless protocols in other embodiments. Communication circuitry 1738 may include antennas to facilitate wireless communications and/or to receive other wireless communications.

In some embodiments, communication circuitry 1738 may manage wired communications, such as electrical, optical, or any other suitable communication protocols (e.g., the Ethernet, Internet). As noted above, communication circuitry 1738 may include multiple communication chips. For instance, a first communication chip may be dedicated to shorter-range wireless communications such as Wi-Fi or Bluetooth, and a second communication chip may be dedicated to longer-range wireless communications such as global positioning system (GPS), EDGE, GPRS, CDMA, WiMAX, LTE, EV-DO, or others. In some embodiments, a first communication chip may be dedicated to wireless communications, and a second communication chip may be dedicated to wired communications.

In various embodiments, communication circuitry 1738 may include receiving circuitry and transmitting circuitry for receiving communication and transmitting (e.g., sending) communication respectively. For example, the receiving circuitry may receive the wallet address comprising blockchain address 404a of wallet 106. In another example, the receiving circuitry may receive various messages from ticketholder-device 102 suitably. In yet another example, the transmitting circuitry may transmit combination 506 to ticketholder-device 102 and display device 124. Various other receiving and transmitting operations may be performed by receiving circuitry and transmitting circuitry of communication circuitry 1738 respectively.

Computing device 1700 may include a power circuitry 1740 comprising battery/power circuitry and other electronic components configured to deliver power to computing device 1700. Power circuitry 1740 may include one or more energy storage devices (e.g., batteries or capacitors) and/or circuitry for coupling components of computing device 1700 to an energy source separate from computing device 1700 (e.g., AC line power).

A number of components are illustrated in the figure as included in computing device 1700, but any one or more of these components may be omitted or duplicated, as suitable for the application. Additionally, in various embodiments, computing device 1700 may not include one or more of the components illustrated in the figure, but computing device 1700 may include interface circuitry for coupling to one or more components. For example, computing device 1700 may not include a display device, but may include display device interface circuitry (e.g., a connector and driver circuitry) to which display device 2406 may be coupled. In some embodiments, computing device 1700 may include peripheral components, such as display devices, keyboard, mouse, audio input/output devices, bar code reader, a Quick Response (QR) code reader, sensors, radio frequency identification (RFID) reader, etc. Display devices may include any visual indicators, such as a heads-up display, a computer monitor, a projector, a touchscreen display, a liquid crystal display (LCD), a light-emitting diode display, or a flat panel display, for example.

Computing device 1700 may have any desired form factor, such as a handheld or mobile computing device (e.g., a cell phone, a smart phone, a mobile Internet device, a tablet computer, a laptop computer, a netbook computer, an ultra-book computer, a personal digital assistant (PDA), an ultramobile personal computer, etc.), a desktop computing device, a server or other networked computing component, a set-top box, an entertainment control unit, a vehicle control unit, or a wearable computing device. In some embodiments, computing device 1700 may be any other electronic device that processes data.

The above description of illustrated implementations of the disclosure, including what is described in the abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

1. A method for electronic ticket validation with non-fungible tokens (NFTs) in a blockchain network, the method executed by a processor of a server in a cloud network, the method comprising:
receiving a wallet address of a wallet in the blockchain network;
querying blockchain data based on the wallet address to identify a NFT identifier in the wallet;
determining whether the NFT identifier matches at least one in a list of pre-approved NFT identifiers;
retrieving a digital image corresponding to the NFT identifier determined to match at least one identifier in the list of pre-approved NFT identifiers;
randomly selecting an animation from a repository of animations, wherein each animation is different from all other animations in the repository;
generating a combination of the selected animation and the retrieved digital image; and
transmitting the combination to a ticketholder-device and to a validation-device for synchronous display by the ticketholder-device and the validation-device.

2. The method of claim 1, further comprising:
identifying a plurality of NFT identifiers in the wallet;
determining whether individual ones in the plurality of NFT identifiers match corresponding ones in the list of pre-approved NFT identifiers;
retrieving digital images corresponding to individual ones in the plurality of NFT identifiers determined to match at least one in the list of pre-approved NFT identifiers;
transmitting the retrieved digital images to the ticketholder-device for display and selection; and
receiving a selection of one of the digital images from the ticketholder-device, wherein the digital image in the combination is the selected one of the digital images.

3. The method of claim 1, further comprising sending, by the server to a wallet application through the ticketholder-device, a request for the wallet address, wherein the wallet application is configured to execute remotely from the server.

4. The method of claim 3, wherein the wallet application is configured to execute in the ticketholder-device.

5. The method of claim 1, further comprising:
generating an electronic ticket; and
associating the electronic ticket with the list of pre-approved NFTs.

6. The method of claim 5, wherein the electronic ticket is one of: (a) a QR-code or (b) a barcode.

7. The method of claim 5, wherein the synchronous display in the ticketholder-device and the validation-device of the combination of the selected animation and the digital image validates the electronic ticket and corresponding entry credentials of a ticketholder.

8. The method of claim 1, wherein the animation is randomly selected after receiving a request for entry from the ticketholder-device.

9. The method of claim 1, wherein:
the NFT identifier is a first NFT identifier,
the digital image is a first digital image,
a second NFT identifier corresponds to a second digital image, and
the second digital image is distinct from the first digital image.

10-36. (canceled)

37. A method for electronic ticket validation with non-fungible tokens (NFTs) in a blockchain network, the method executed by a processor of a server in a cloud network, the method comprising:
receiving a first wallet address of a first wallet in the blockchain network;
querying blockchain data based on the first wallet address to identify a contract address of a first token in the first wallet;
determining whether the contract address of the first token matches at least one in a list of pre-approved contract addresses;
querying blockchain data based on the contract address determined to be a match of at least one in the list of pre-approved contract addresses to identify a second token sharing a common identifier with the first token;
identifying, from the second token, a second wallet address of a second wallet having the second token;
querying blockchain data based on the second wallet address to identify an NFT identifier in the second wallet;
determining whether the NFT identifier matches at least one in a list of pre-approved NFT identifiers;
retrieving a digital image corresponding to the NFT identifier determined to match at least one identifier in the list of pre-approved NFT identifiers;
randomly selecting an animation from a repository of mutually distinct animations;
generating a combination of the selected animation and the retrieved digital image; and
transmitting the combination to a ticketholder-device and to a validation-device for synchronous display by the ticketholder-device and the validation-device.

38. The method of claim 37, further comprising:
identifying a plurality of NFT identifiers in the second wallet;
determining whether individual ones in the plurality of NFT identifiers match corresponding ones in the list of pre-approved NFT identifiers;
retrieving digital images corresponding to individual ones in the plurality of NFT identifiers determined to match at least one in the list of pre-approved NFT identifiers;
transmitting the retrieved digital images to the ticketholder-device for display and selection; and
receiving a selection of one of the digital images from the ticketholder-device, wherein the digital image in the combination is the selected one of the digital images.

39. The method of claim 37, further comprising:
generating an electronic ticket; and
associating the electronic ticket with the list of pre-approved NFTs.

40. The method of claim 39, wherein the electronic ticket is one of: (a) a QR-code or (b) a barcode.

41. The method of claim 39, wherein the synchronous display in the ticketholder-device and the validation-device of the combination of the selected animation and the digital image validates the electronic ticket and corresponding entry credentials of a ticketholder.

42. The method of claim 37, wherein the animation is randomly selected after receiving a request for entry from the ticketholder-device.

43. The method of claim 37, wherein:
the NFT identifier is a first NFT identifier,
the digital image is a first digital image,
a second NFT identifier corresponds to a second digital image, and
the second digital image is distinct from the first digital image.

44-64. (canceled)

65. A method for electronic ticket validation with non-fungible tokens (NFTs) in a blockchain network, the method executed by a processor of a server in a cloud network, the method comprising:
receiving a wallet address of a wallet in the blockchain network;
querying blockchain data based on the wallet address to identify a NFT identifier in the wallet;
determining whether the NFT identifier matches at least one in a list of pre-approved NFT identifiers;
retrieving a digital image corresponding to the NFT identifier determined to match at least one identifier in the list of pre-approved NFT identifiers; and
transmitting the digital image to a ticketholder-device and to a validation-device for synchronous display by the ticketholder-device and the validation-device.

66. The method of claim 65, wherein the digital image is a first digital image, and the method further comprises:
randomly selecting a second digital image from a repository of digital images, wherein digital images in the repository are different from each other;
generating a combination of the first and second digital images; and
transmitting the combination to a ticketholder-device and to a validation-device for synchronous display by the ticketholder-device and the validation-device.

67. The method of claim 66, wherein the second digital image is a solid color swatch.

68. The method of claim 66, wherein the second digital image is randomly selected after receiving a request for entry from the ticketholder-device.

69. The method of claim 65, further comprising:
identifying a plurality of NFT identifiers in the wallet;
determining whether individual ones in the plurality of NFT identifiers match corresponding ones in the list of pre-approved NFT identifiers;
retrieving digital images corresponding to individual ones in the plurality of NFT identifiers determined to match at least one in the list of pre-approved NFT identifiers;
transmitting the retrieved digital images to the ticketholder-device for display and selection; and
receiving a selection of one of the digital images from the ticketholder-device, wherein the digital image transmitted to the ticketholder-device and to the validation device is the selected one of the digital images.

70. The method of claim 65, further comprising sending, by the server to a wallet application through the ticketholder-device, a request for the wallet address, wherein the wallet application is configured to execute remotely from the server.

71. The method of claim 70, wherein the wallet application is configured to execute in the ticketholder-device.

72. The method of claim 65, further comprising:
generating an electronic ticket; and
associating the electronic ticket with the list of pre-approved NFTs.

73. The method of claim 72, wherein the electronic ticket is one of: (a) a QR-code or (b) a barcode.

74. The method of claim 72, wherein the synchronous display in the ticketholder-device and the validation-device of the combination of the first and second digital images validates the electronic ticket and corresponding entry credentials of a ticketholder.

75. The method of claim 65, wherein digital images corresponding to different NFT identifiers are correspondingly different.
